(19) United States
(12) Patent Application Publication
(10) Pub. No.: US 2021/0206191 A1
(43) Pub. Date: Jul. 8, 2021

(54) FLYER HAVING FUNCTION OF ENCLOSING INNER SHEETS

(71) Applicant: CHENG LOONG CORPORATION, New Taipei City (TW)

(72) Inventor: YUNG-CHANG LEE, TAOYUAN CITY (TW)

(21) Appl. No.: 16/892,640

(22) Filed: Jun. 4, 2020

(30) Foreign Application Priority Data
Jan. 6, 2020 (TW) 109200131

(51) Int. Cl. B42D 1/00; G09F 1/04

(52) U.S. Cl. CPC B42D 1/006; G09F 23/10; G09F 1/04

(57) ABSTRACT

A flyer includes a cover sheet that is divided by two first folding line into three portions, and inner sheets which are each divided by a second folding line into two portions and are stacked and fixed together by aligning the second folding lines. The inner sheets have a length smaller than a length of two adjacent portions of the cover sheet. The inner sheets have a width identical to a width of the cover sheet. The second folding line is set in alignment with one of the first folding line and the inner sheets are fixed to inner surfaces of two adjacent portions of the cover sheet, while the remaining portion of the cover sheet forms a covering section, through proper folding of the cover sheet and the inner sheets, the inner sheets are enclosed inside the cover sheet to thereby improve the protection of the inner sheets.

### FIELD OF THE INVENTION

The present invention relates to a flyer, and more particular to a flyer having a function of enclosing inner sheets, in which a cover sheet is arranged to enclose inner sheets.

### BACKGROUND OF THE INVENTION

In the modern prosperous commerce environment, shopping malls and department stores often release information of promotion and discount by mailing or distributing flyers or circulars to the consumers for the attempt of impressing the consumers and also for increasing sales and profit. Also, businesses may provide and distribute flyers or pamphlets or leaflets to visitors for a brief introduction of the businesses.

As shown in FIGS. 12-14, a conventional flyer 20 is often structured by cutting multiple sheets of paper 21 into the same size and saddle staples 22 are applied to a mid-folding line L3 of the paper sheets 21, so that the flyer 20 may then be folded in half along the mid-folding line L3 and mailed or distributed. To prevent the flyer 20 from undesirably opening during mailing, which may lead to unwanted damage to the flyer, a seal sticker 23 is sometimes attached to an edge of the conventional flyer 20 to fix the paper sheets together. However, the other portions of the paper sheets that are not attached by the seal sticker 23 would still be potentially opened without being properly constrained, leading to damage and poor appearance. Further, saddle staples 22 or other means of stitching or stapling are generally not very environment-friendly and may cause safety concerns, and in certain areas or countries, such staples do not meet local regulations. Further, name strips may be attached to the flyers on an outer surface thereof to indicate the name and address of a designated receiver. This again is not environment-friendly and requires additional labor and working.

The overall view of the above, the present invention aims to provide a flyer that is capable of enclosing and covering an inner sheet, which in order to overcome the above-discussed shortcoming of the prior art and to enhance industrial utilization.

### SUMMARY OF THE INVENTION

The primary objective of the present invention is to provide a flyer that features enclosure of inner sheets, so that folding of a cover sheet and the inner sheets make the inner sheets completely enclosed inside the cover sheet and consequentially, damage to the inner sheets during shipping can be avoided and an outside appearance is made aesthetic. Further, the cover sheet and the inner sheets are fixed together through adhesive bonding so that no saddle staple or other stapling is involved in bonding, achieving an effect of compliance with environmental regulations and being free of safety concern to thereby completely meet the requirements stipulated by laws and regulations of certain areas.

Thus, to achieve the above objective, the present invention provides a flyer having a function of enclosing inner sheets, comprising: a cover sheet, the cover sheet being divided by two first folding lines into a first portion, a second portion, and a third portion; and a plurality of inner sheets, the inner sheets having a length that does not exceed a length of the first portion and the second portion of the cover sheet, the inner sheets having a width that corresponds to a width of the cover sheet, wherein the inner sheets are each divided by a second folding line into a first portion and a second portion and are stacked on and fixed to each other with the second folding lines thereof in alignment with each other; wherein the second folding lines are in alignment with the first fold line between the first portion and the second portion of the cover sheet; the inner sheets are stacked on and fixed to inner surfaces of the first portion and the second portion of the cover sheet, and the third portion of the cover sheet forms a covering section; and the first portion and the third portion of the cover sheet are sequentially folded inward along the two first folding lines so as to have the inner sheets enclosed inside the cover sheet.

In the above flyer having a function of enclosing inner sheets, the first portion and the second portion of the inner sheets are divided by the second folding line into equal portions having identical sizes.

In the above flyer having a function of enclosing inner sheets, one of the inner sheets is arranged on an upper level has a length that is smaller than a length of one of the inner sheets is arranged on a lower level, the first portions of the inner sheets being of sizes identical to each other, the second portion of one of the inner sheets where is arranged on the upper level having a size that is smaller than a size of the second portion of the one of the inner sheets where is arranged on the lower level, side edges of the first portions of the inner sheets being in alignment with a side edge of the first portion of the cover sheet, a page index section being provided on side edges of the second portions of the inner sheets.

In the above flyer having a function of enclosing inner sheets, the inner sheets have lengths that are identical to each other, and the inner sheets are arranged, in sequence from the upper level to the lower level, such that the second folding lines of the inner sheets are arranged closer to side edges of the first portions of the inner sheets in that sequence, so that when the inner sheets are folded, a page index section is formed between the first portion and the second portion of each of the inner sheets.

In the above flyer having a function of enclosing inner sheets, the inner sheets are fixed, through adhesive bonding, to inner surfaces of the first portion and the second portion of the cover sheet.

In the above flyer having a function of enclosing inner sheets, the third portion of the cover sheet is inward foldable and a side edge of the third portion of the cover sheet is adhesively attachable to an outer surface of the first portion of the cover sheet.

In the above flyer having a function of enclosing inner sheets, the first portion, the second portion, and the third portion of the cover sheet are divided by the two first folding lines into equal portions of identical sizes.

In the above flyer having a function of enclosing inner sheets, the cover sheet is divided by the two first folding line into the first portion and the second portion that are of identical sizes and the third portion of the cover sheet has a size smaller than the size of the first portion of the cover sheet.

In the above flyer having a function of enclosing inner sheets, the third portion of the cover sheet is inward foldable and the third portion of the cover sheet is attachable to the first portion or second portion of the cover sheet by an adhering piece.

In the above flyer having a function of enclosing inner sheets, the third portion of the cover sheet has an outer surface that is printed with contact information.

In summary, the present invention provides innovation in respect of spatial arrangement and further provides various additional functions as compared to the prior art, and as such, the present invention is novel and inventive.

### BRIEF DESCRIPTION OF THE DRAWINGS

FIG. 1 is an exploded view showing a flyer having a function of enclosing inner sheets according to the present invention;

FIG. 2 is a perspective view showing the flyer having a function of enclosing inner sheets according to an embodiment of the present invention;

FIGS. 3-5 are schematic views demonstrating a process of folding the flyer having a function of enclosing inner sheets according to the present invention;

FIGS. 6-8 are schematic views showing a flyer having a function of enclosing inner sheets according to another embodiment the present invention and demonstrating a process of folding the flyer;

FIGS. 9-11 are schematic views showing a flyer having a function of enclosing inner sheets according to a further embodiment the present invention and demonstrating a process of folding the flyer; and

FIGS. 12-14 are schematic views showing a conventional flyer and demonstrating a process of folding the conventional flyer.

### DETAILED DESCRIPTION OF THE PREFERRED EMBODIMENTS

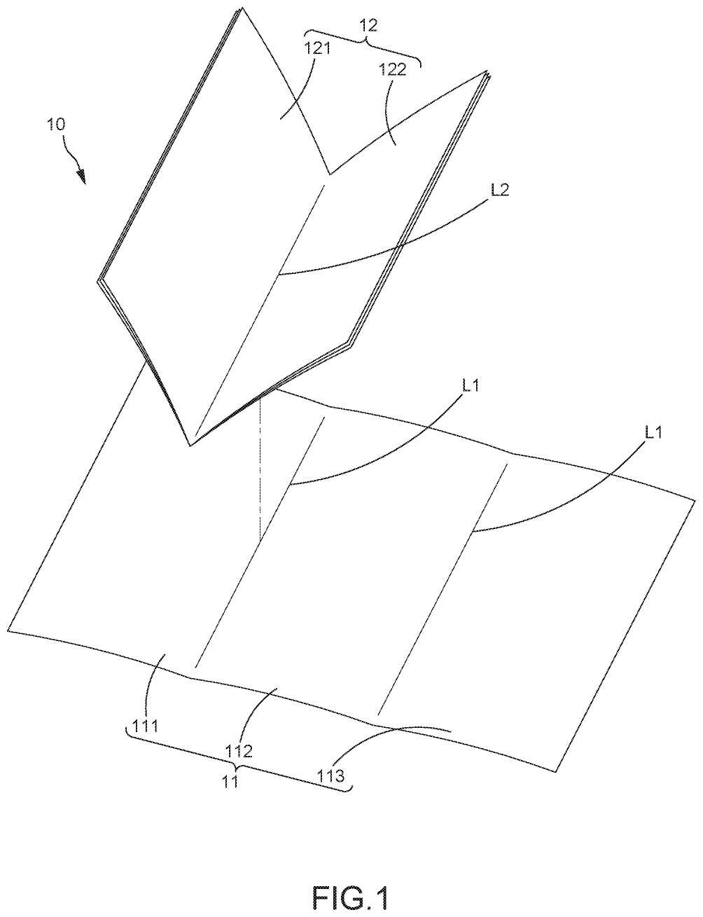

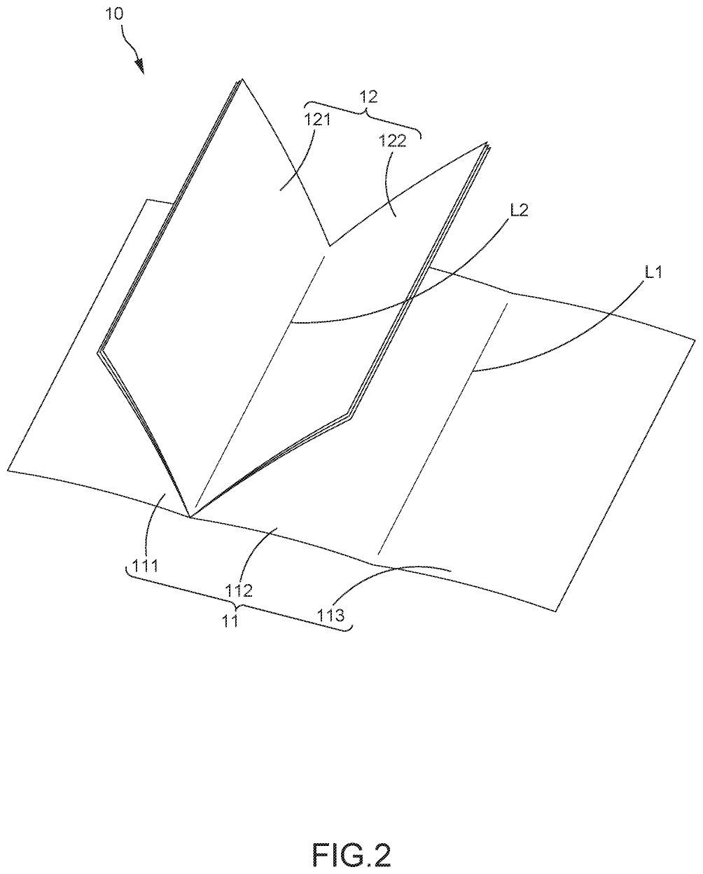

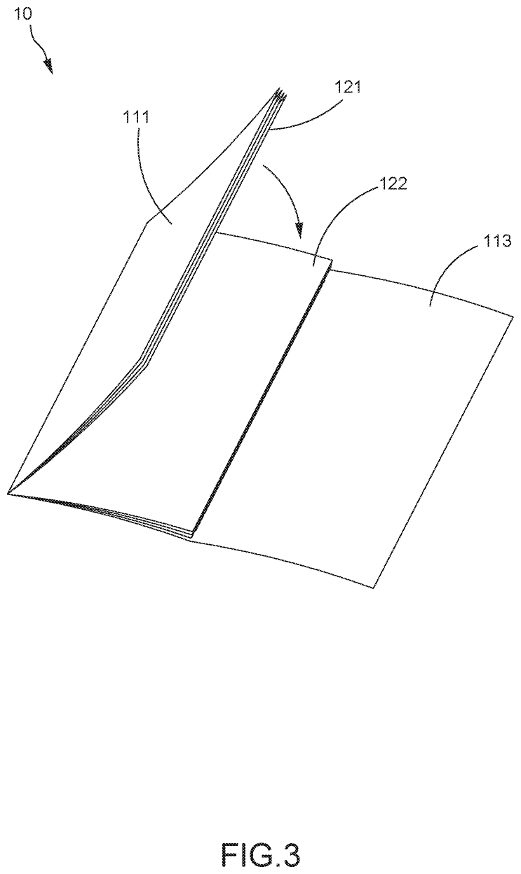

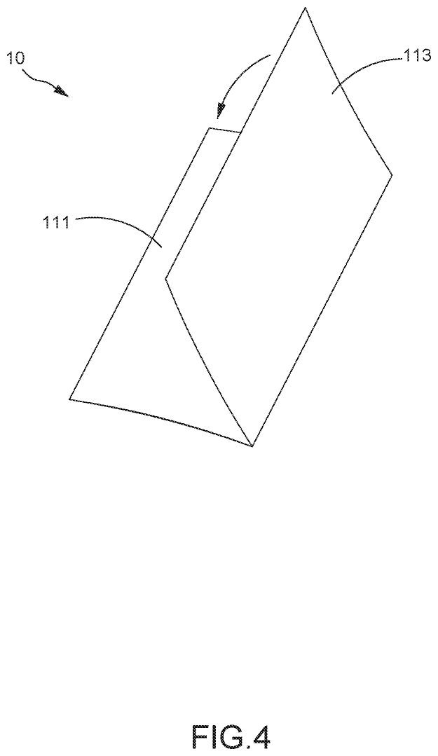

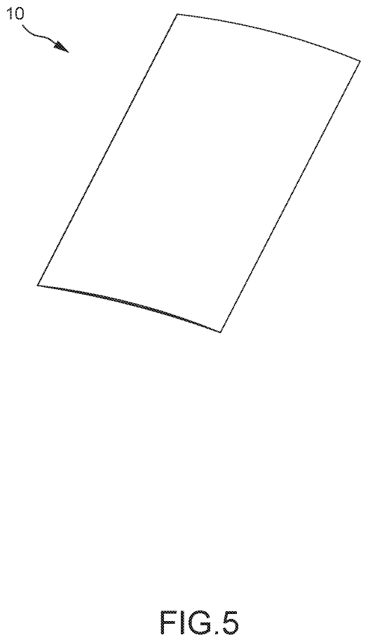

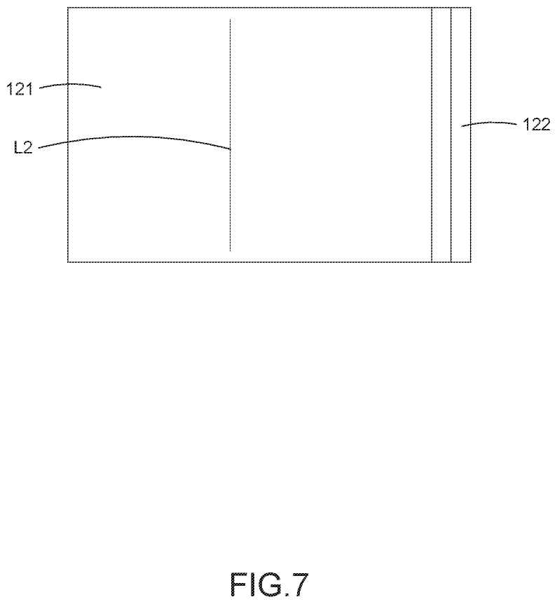

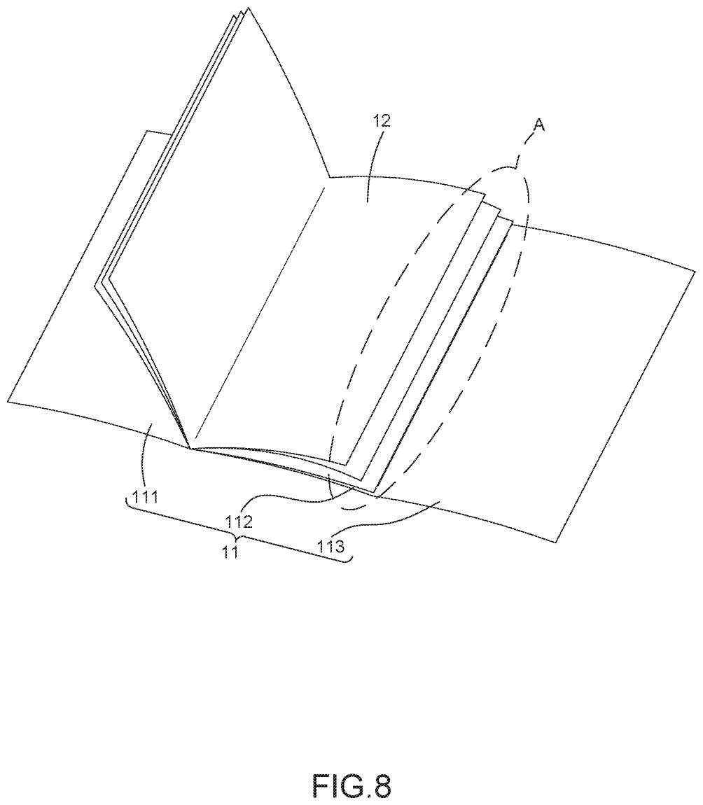

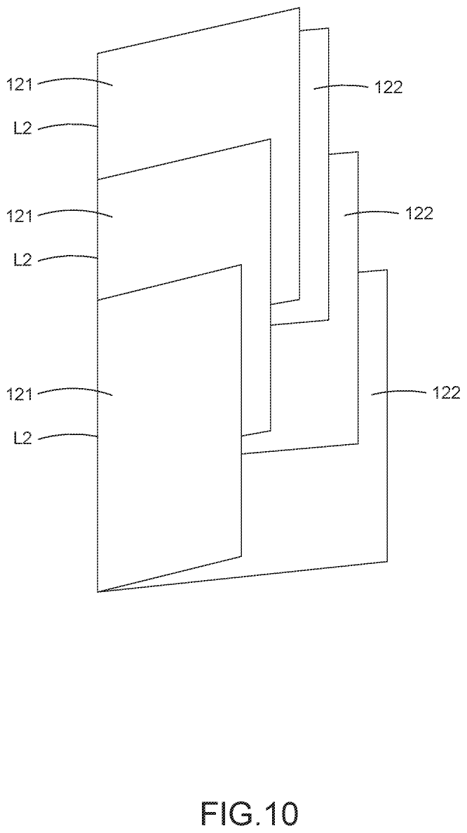

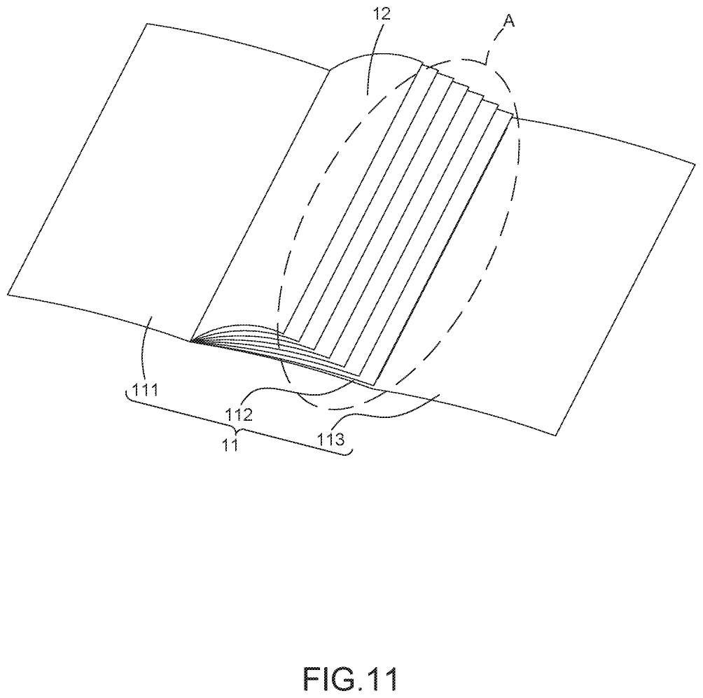

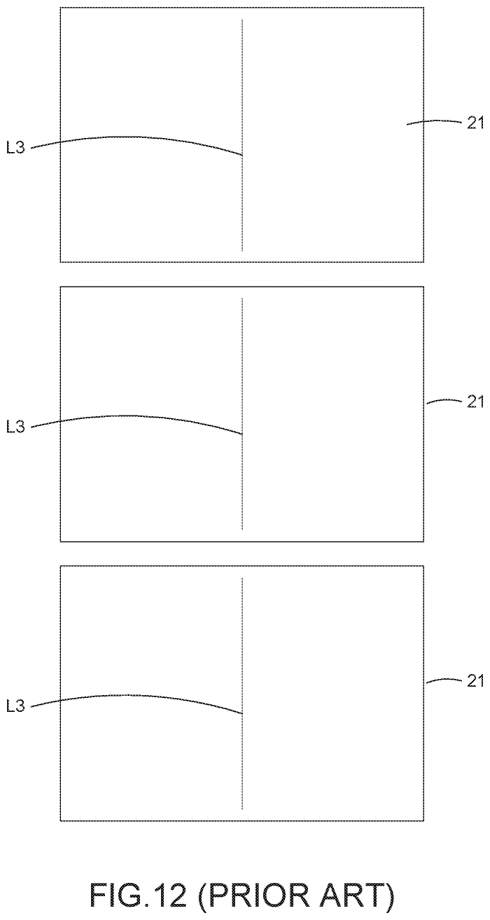

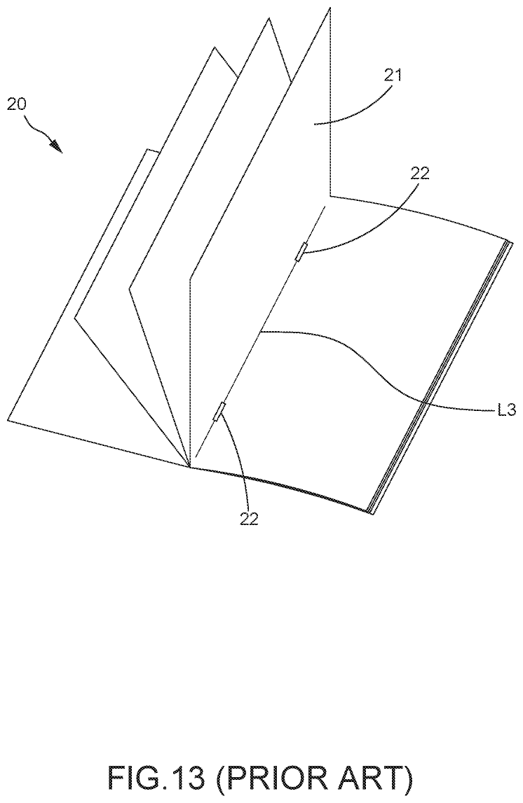

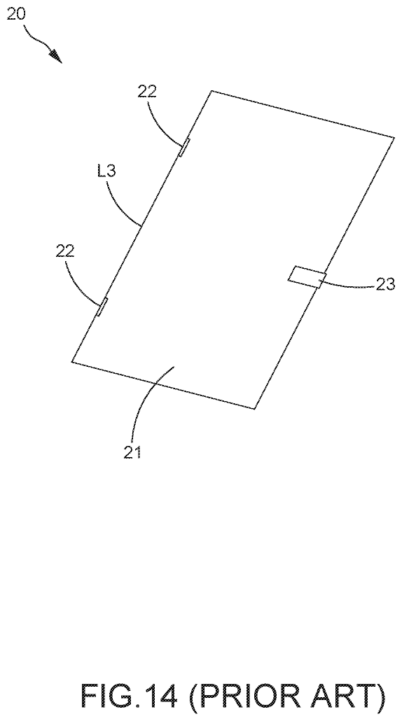

Embodiments of the present invention will be described with reference to FIGS. 1-11. The description is not intended to limit the ways of embodying the present invention and is instead provided as an example of an embodiment of the present invention. Also, in the drawings and specification, similar or same references are used to designate the same, substantially identical, or functionally identical parts and elements through all the drawings. The drawings are provided in a simplified form and the drawings are not drawn to exact scale in all the embodiments illustrated.

Firstly, referring collectively to FIGS. 1-5, a flyer having a function of enclosing an inner sheet according to the present invention, generally designated at 10, comprises: a cover sheet 11, wherein the cover sheet 11 is divided by two first folding line L1 into a first portion 111, a second portion 112, and a third portion 113; and a plurality of inner sheets 12, wherein the inner sheets 12 have a length that does not exceed a length of the first portion 111 and the second portion 112 of the cover sheet 11 and the inner sheets 12 has a width that corresponds to a width of the cover sheet 11, and the inner sheets 12 are each divided by a second folding line L2 into a first portion 121 and a second portion 122 and are stacked and fixed together with the second folding line L2 in alignment with each other, wherein the second folding line L2 are set in alignment with the first fold line L1 between the first portion 111 and the second portion 112 of the cover sheet 11, so as to have the inner sheets 12 stacked on and attached to inner surfaces of the first portion 111 and the second portion 112 of the cover sheet 11, and the third portion 113 of the cover sheet 11 forms a covering section, and further, the first portion 111 and the third portion 113 of the cover sheet 11 are sequentially folded inward along the two first folding line L1 so as to have the inner sheets 12 enclosed inside the cover sheet 11. As such, the flyer has a function of enclosing an inner sheet, as designated at 10, according to the present invention allows the inner sheets 12 to be completely enclosed inside the cover sheet 11 through folding the cover sheet 11 and the inner sheets 12, and thus, the inner sheets 12 are protected from damage during shipping and are kept with an aesthetic appearance.

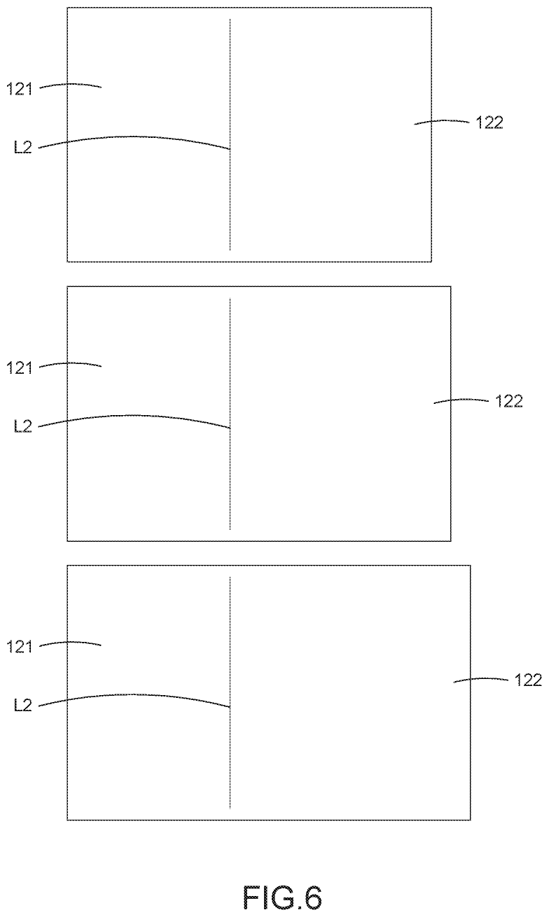

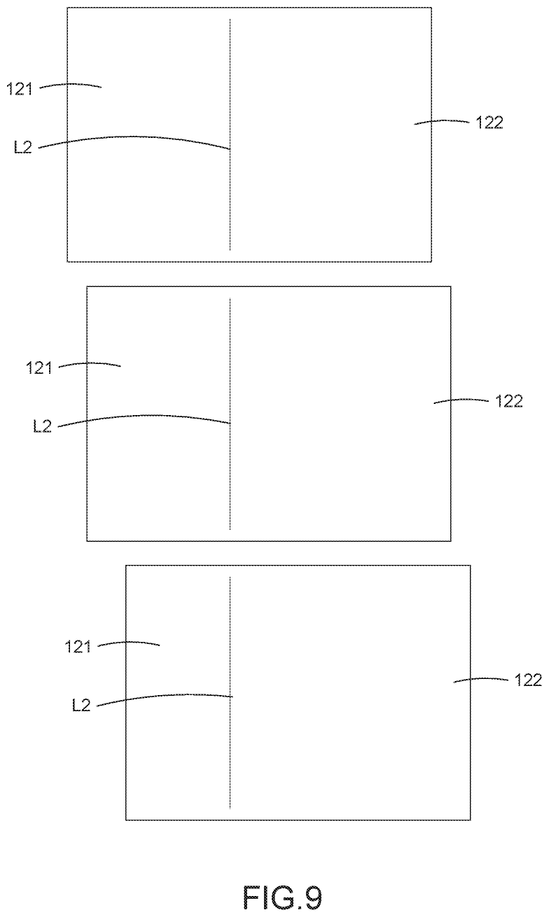

In the flyer provided in the above embodiment, the first portion 121 and the second portion 122 of the inner sheets 12 are divided by the second folding line L2 as two equal portions of the same size. However, to provide the inner sheets 12 with a page index section A for a page indication function, the inner sheets 12 can be modified in one of the following alternative forms. In a first alternative form, referring to FIGS. 6-8, the inner sheet 12 on an upper level has a length that is smaller than a length of the inner sheet 12 on a lower level; the first portions 121 of the inner sheets 12 have the identical size, while the second portion 122 of the inner sheet 12 on the upper level has a size that is smaller than a size of the second portion 122 of the inner sheet 12 on the lower level; and side edges of the first portions 121 of the inner sheets 12 are set in alignment with a side edge of the first portion 121 of the cover sheet 11, while side edges of the second portions 122 of the inner sheets 12 each form a page index section A. In a second alternative form, referring to FIGS. 9-11, the lengths of the inner sheets 12 are all identical and the inner sheets 12 are arranged, in sequence from a lower level to an upper level, in such a manner that the second folding lines L2 are set closer to the side edges of the first portions 121 of the inner sheets 12 in that sequence, so that when the inner sheets 12 are folded, a page index section A is formed between the side edges of the first portion 121 and the second portion 122 of each of the inner sheets 12. As such, for some of the inner sheets 12 are classified as being of the same topics, a user may quickly turn to a desired page for viewing by applying the page index sections A.

However, for each of the embodiments discussed above, the inner sheets 12 can be attached, through adhesive bonding, to inner surfaces of the first portion 111 and the second portion 112 of the cover sheet 11, so that the flyer having a function of enclosing an inner sheet, as designated at 10, according to the present invention requires no saddle staples or other stapling or stitching to bond the cover sheet 11 and the inner sheets 12 together, and, as such, would provide an advantage of environmental conservation and free of safety concern, and thus meeting the requirement stipulated in local laws and regulations of certain areas. Further, when the third portion 113 of the cover sheet 11 is folded inward, a side edge of the third portion 113 of the cover sheet 11 adheres to an outer surface of the first portion 111 of the cover sheet 11. For example, a side edge of the third portion 113 of the cover sheet 11 is adhered, through application of adhesive thereto, to an outer surface of the first portion 111 of the cover sheet 11, and since the first portion 111, the second portion 112, and the third portion 113 of the cover sheet 11 are of the same size as being equally divided by the two first folding line L1, when the first portion 111 and the third portion 113 of the cover sheet 11 are sequentially folded inward along the two first folding line L1, the third portion 113 of the cover sheet 11 may completely covers the first portion 111 of the cover sheet 11, or alternatively, the cover sheet 11 is divided by the two first folding line L1 in such a way that the first portion 111 and the second portion 112 are of the same size and the third portion 113 of the cover sheet 11 has a size smaller than the size of the first portion 111 of the cover sheet 11, so that similarly, a side edge of the third portion 113 of the cover sheet 11 can be adhesively attached to an outer surface of the first portion 111 of the cover sheet 11 and in this way, the inner sheets 12 are protected from damage during shipping and a receiver, upon opening the flyer having a function of enclosing an inner sheet as designated at 10, would not tear apart and damage the inner sheets 12, allowing the receiver to clearly read the contents printed on the inner sheets 12, or further alternatively, the third portion 113 of the cover sheet 11 is folded inward and then the third portion 113 of the cover sheet 11 is similarly adhered, by means of an adhering piece (not shown), to the first portion 111 or the second portion 112 of the cover sheet 11. For example, the third portion 113 of the cover sheet 11 can be adhesively fixed, by a seal (such as a sticker), to the first portion 111 or the second portion 112 of the cover sheet 11. Finally, for each of the above-discussed embodiments, it is possible to directly print contact information (not shown), such as the name and address, of a receiver on an outer surface of the third portion 113 of the cover sheet 11, so that there is no need to attach an additional name strip that carries contact information, such as name and address, of the receiver to the outside surface of the third portion 113 of the cover sheet 11. This would be environment-friendly and also helps reduce working time and labor.

Thus, the present invention provides a flyer having a function of enclosing an inner sheet, which allows the inner sheets to be completely enclosed inside the cover sheet by folding the cover sheet and the inner sheets, which so as to prevent the inner sheets from being damaged during shipping and keep the aesthetic appearance. Further, the cover sheet and the inner sheets can be fixed together through adhesive bonding without use of saddle staples or other stapling or stitching, which so as to provide an advantage of being environment-friendly and being free of safety concern, and also meeting requirements stipulated in local laws and regulations of certain areas.

The above description provides the explanation and illustration of preferred embodiments of the present invention, which are not intended to limit the scope of the present invention. Equivalent modification and alteration according to the contents of the specification and drawings of the present invention are considered belonging to the scope of the present invention that is defined solely by the appended claims.

What is claimed is:

1. A flyer having a function of enclosing inner sheets, comprising:
a cover sheet, the cover sheet being divided by two first folding line into a first portion, a second portion, and a third portion; and
a plurality of inner sheets, the inner sheets having a length that does not exceed a length of the first portion and the second portion of the cover sheet, the inner sheets having a width that corresponds to a width of the cover sheet, wherein the inner sheets are each divided by a second folding line into a first portion and a second portion and are stacked on and fixed to each other with the second folding lines thereof in alignment with each other;
wherein the second folding lines are in alignment with the first fold line between the first portion and the second portion of the cover sheet; the inner sheets are stacked on and fixed to inner surfaces of the first portion and the second portion of the cover sheet, and the third portion of the cover sheet forms a covering section; and the first portion and the third portion of the cover sheet are sequentially folded inward along the two first folding line which so as to have the inner sheets enclosed inside the cover sheet.

2. The flyer having a function of enclosing inner sheets according to claim 1, wherein the first portion and the second portion of the inner sheets are divided by the second folding line into equal portions having identical sizes.

3. The flyer having a function of enclosing inner sheets according to claim 1, wherein one of the inner sheets that is arranged on an upper level has a length that is smaller than a length of one of the inner sheets that is arranged on a lower level, the first portions of the inner sheets being of sizes identical to each other, the second portion of the one of the inner sheets that is arranged on the upper level having a size that is smaller than a size of the second portion of the one of the inner sheets that is arranged on the lower level, side edges of the first portions of the inner sheets being in alignment with a side edge of the first portion of the cover sheet, a page index section being provided on side edges of the second portions of the inner sheets.

4. The flyer having a function of enclosing inner sheets according to claim 1, wherein the inner sheets have lengths that are identical to each other, and the inner sheets are arranged, in sequence from the upper level to the lower level, such that the second folding line of the inner sheets are arranged closer to side edges of the first portions of the inner sheets in that sequence, so that when the inner sheets are folded, a page index section is formed between the first portion and the second portion of each of the inner sheets.

5. The flyer having a function of enclosing inner sheets according to claim 1, wherein the inner sheets are fixed, through adhesive bonding, to inner surfaces of the first portion and the second portion of the cover sheet.

6. The flyer having a function of enclosing inner sheets according to claim 5, wherein the third portion of the cover sheet is inward foldable and a side edge of the third portion of the cover sheet is adhesively attachable to an outer surface of the first portion of the cover sheet.

7. The flyer having a function of enclosing inner sheets according to claim 6, wherein the first portion, the second portion, and the third portion of the cover sheet are divided by the two first folding line into equal portions of identical sizes.

8. The flyer having a function of enclosing inner sheets according to claim 6, wherein the cover sheet is divided by the two first folding line into the first portion and the second portion that are of identical sizes and the third portion of the cover sheet has a size smaller than the size of the first portion of the cover sheet.

9. The flyer having a function of enclosing inner sheets according to claim 5, wherein the third portion of the cover sheet is inward foldable and the third portion of the cover sheet is attachable to the first portion or second portion of the cover sheet by an adhering piece.

10. The flyer having a function of enclosing inner sheets according to claim 6, wherein the third portion of the cover sheet has an outer surface that is printed with contact information.

11. The flyer having a function of enclosing inner sheets according to claim 9, wherein the third portion of the cover sheet has an outer surface that is printed with contact information.
